(19) United States
(12) Patent Application Publication
(10) Pub. No.: US 2026/0050343 A1
(43) Pub. Date: Feb. 19, 2026

(54) DISPLAY PANEL AND DISPLAY DEVICE

(71) Applicant: Guangzhou China Star Optoelectronics Semiconductor Display Technology Co., LTd., Guangzhou (CN)

(72) Inventor: Yuanxiang XIE, Guangzhou (CN)

(73) Assignee: Guangzhou China Star Optoelectronics Semiconductor Display Technology Co., LTd., Guangzhou (CN)

(21) Appl. No.: 18/964,411

(22) Filed: Nov. 30, 2024

(30) Foreign Application Priority Data
Aug. 16, 2024 (CN) 202411131702.3

(51) Int. Cl. G06F 3/041; G02F 1/1362; G02F 1/1368; G06F 3/044

(52) U.S. Cl. CPC G06F 3/04182; G02F 1/136286; G02F 1/1368; G06F 3/0446; G06F 2203/04107

(57) ABSTRACT

A display panel is provided by the present application. The display panel has a display area. The display panel includes a substrate, a first conductive layer and a common electrode layer. The first conductive layer is arranged on a side of the substrate and includes multiple data lines arranged in a first direction, the data lines are arranged in the display area. The common electrode layer is arranged on a side of the first conductive layer and the substrate, and includes multiple common electrode blocks arranged in an array along the first direction and a second direction. The common electrode blocks are located in the display area. Each common electrode block is reused as one touch electrode. At least one of the common electrode blocks includes a first opening. The first direction intersects with the second direction.

### CROSS-REFERENCE TO RELATED APPLICATION

This application claims the priority of Chinese Application No. 202411131702.3 filed on Aug. 16, 2024, the contents of which are incorporated herein by reference in their entirety.

### TECHNICAL FIELD

The present disclosure relates to the field of display technology, and in particular to a display panel and a display device.

### BACKGROUND

Touch technology is an important technology for interaction between humans and display screens. In existing art, for embedded touch display panels (such as in-cell display panels), touch functions are integrated in the display panels. For liquid crystal display panels, touch functions are integrated in the display panels by dividing a transparent common electrode inside the panel into blocks, and connecting touch signal lines (touch traces) to each common electrode block through contact holes to realize a monitoring of touch signals of each block. As the size and resolution of the touch display panels increase, the touch signal-to-noise ratio reduces, resulting in poor touch performance.

### SUMMARY

In view of this, the present application provides a display panel and a display device to alleviate the problem of a reduced touch signal-to-noise ratio of the display panel, thereby improving the touch performance of the display panel.

In a first aspect, the present application provides a display panel. The display panel includes a display area. The display panel includes a substrate, a first conductive layer, and a common electrode layer. The first conductive layer is arranged on a side of the substrate and includes multiple data lines arranged in a first direction. The data lines are arranged in the display area. The common electrode layer is arranged on a side of the first conductive layer and the substrate, and includes multiple common electrode blocks arranged in an array along the first direction and a second direction. The common electrode blocks are located in the display area. Each common electrode block is reused as one touch electrode. At least one of the common electrode blocks includes a first opening. An orthographic projection of the first opening on the substrate overlaps with an orthographic projection of at least one of the data lines on the substrate, and the first direction intersects with the second direction.

In a second aspect, the present application further provides a display device, the display device includes the display panel described above.

In the display panel and display device of some embodiments of the present application, at least one common electrode block includes a first opening, and the orthographic projection of the first opening on the substrate overlaps with the orthographic projection of at least one of the data lines on the substrate. With this arrangement, an overlapping area between the common electrode block and at least one of the data lines is reduced, so that a parasitic capacitance between the common electrode block, when reused as a touch electrode, and the data line is reduced, and the problem of a large parasitic capacitance leading to a reduced touch signal-to-noise ratio is alleviated, thereby improving the touch performance of the display panel.

### BRIEF DESCRIPTION OF THE DRAWINGS

FIG. 1 is a schematic diagram of a planar structure of a display panel according to some embodiments of the present application;

FIG. 2 is a partially enlarged schematic diagram of part A in FIG. 1 according to some embodiments of the present application;

FIG. 3 is a schematic diagram of a cross-sectional structure of the display panel taken along the line B-B′ in FIG. 2;

FIG. 4 is a schematic plan view of a common electrode layer in FIG. 2;

FIG. 5 is a partially enlarged schematic diagram of a second structure of part A in FIG. 1 according to some embodiments of the present application;

FIG. 6 is a schematic diagram of a cross-sectional structure of the display panel taken along the line C-C′ in FIG. 5;

FIG. 7 is a schematic plan view of a common electrode layer in FIG. 5;

FIG. 8 is a diagram showing a luminous efficiency of a pixel electrode shown in FIG. 5;

FIG. 9 is a schematic diagram of a cross-sectional structure of a display panel according to other embodiments of the present application; and

FIG. 10 is a schematic diagram of a cross-sectional structure of a display panel according to other embodiments of the present application.

### DETAILED DESCRIPTION

In the following, the solutions in the embodiments of the present disclosure are clearly and completely described with reference to the accompanying drawings. It should be noted that the described embodiments are merely a part of the embodiments of the present disclosure, rather than all the embodiments. Based on the embodiments in the present disclosure, all other embodiments obtained by a person skilled in the art without involving any inventive effort are within the scope of the present disclosure.

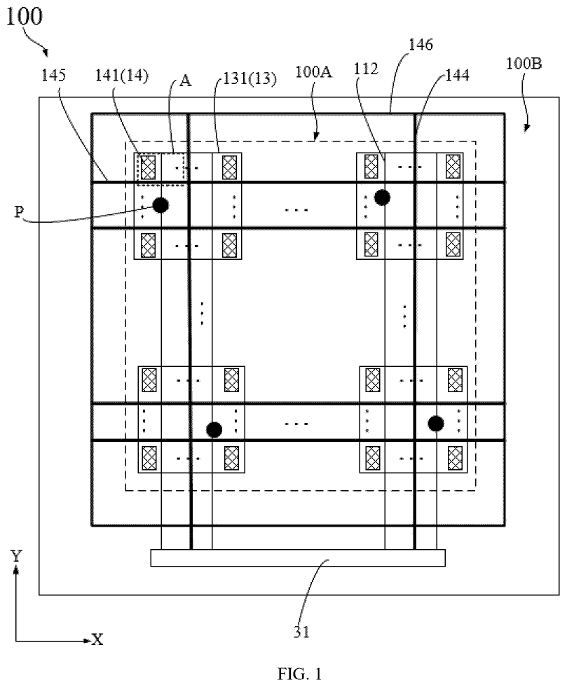

As shown in FIG. 1 to FIG. 7 and FIG. 9 to FIG. 10, the present application provides a display panel 100. The display panel 100 may be a liquid crystal display panel or an organic light-emitting diode display panel. For example, the display panel 100 is a liquid crystal display panel, but not limited to this.

As shown in FIG. 1 to FIG. 3 and FIG. 5 to FIG. 6, the display panel 100 has a display area of 100A for display. The display panel 100 includes an array substrate 10. The array substrate 10 includes a substrate 101, a first conductive layer 11, and a common electrode layer 13.

The substrate 101 may include a hard substrate such as a glass substrate, or a flexible substrate such as a polymer substrate.

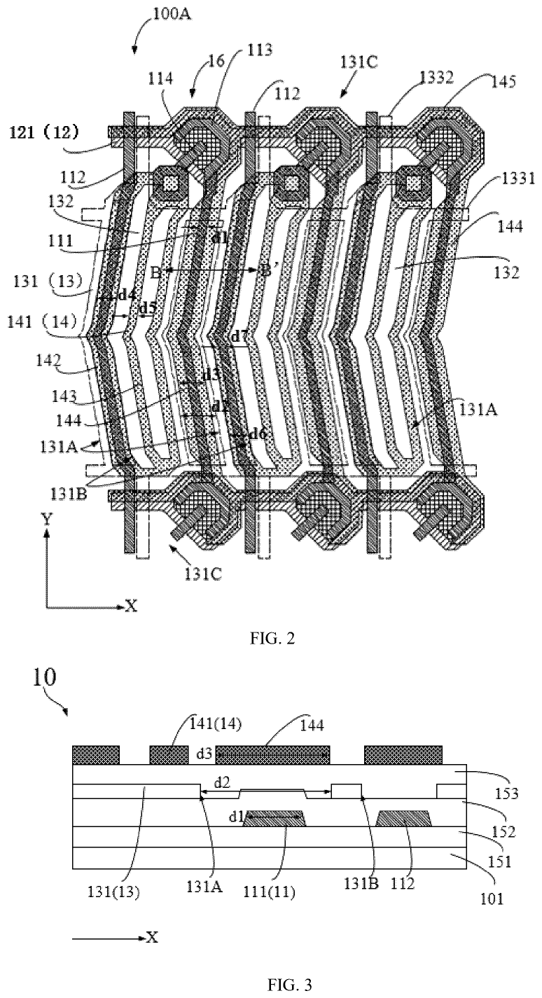

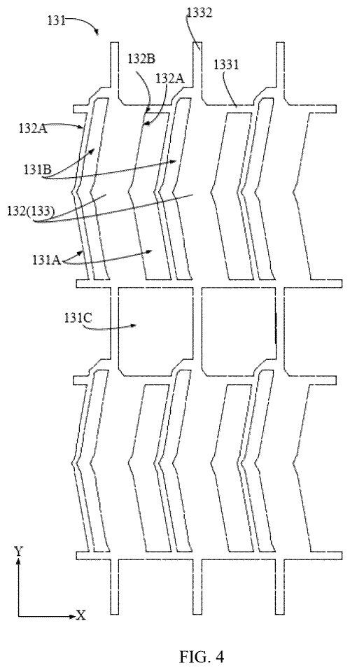

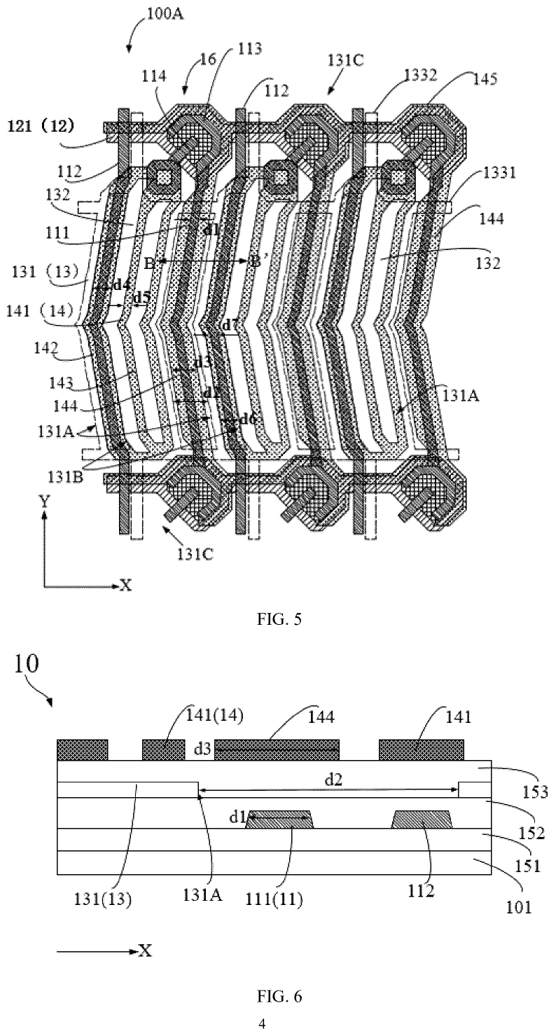

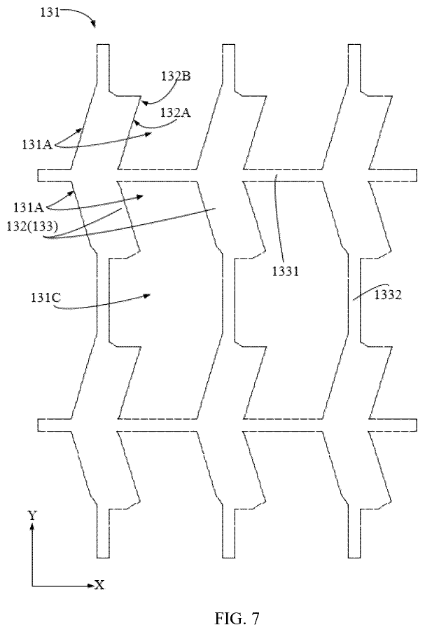

As shown in FIG. 3 and FIG. 6, the first conductive layer 11 is arranged on a side of the substrate 101. As shown in FIG. 2 and FIG. 5, the first conductive layer 11 includes multiple data lines 111 arranged along a first direction X. The data lines 111 are arranged in the display area 100A. The first conductive layer 11 is made of a material including at least one of a metal material and a transparent conductive material. For example, the first conductive layer 11 is made of a material including a metal material selected from at least one of molybdenum, aluminum, titanium, copper, and silver.

As shown in FIG. 3 and FIG. 6, the common electrode layer 13 is arranged on a side of the substrate 101 and the first conductive layer 11. As shown in

FIG. 1, the common electrode layer 13 includes multiple common electrode blocks 131 arranged in an array along the first direction X and a second direction Y. The first direction X intersects with the second direction Y. The common electrode blocks 131 are located in the display area 100A. Each of the common electrode blocks 131 is reused as a touch electrode, so that the common electrode blocks 131 not only transmit a common voltage signal when displaying on the display panel 100, but also detect a touch operation when implementing a touch function on the display panel 100. The common electrode layer 13 is made of a material including a transparent conductive material, and the transparent conductive material include at least one of indium tin oxide and indium zinc oxide.

In some embodiments, as shown in FIG. 2 to FIG. 7, at least one of the common electrode blocks 131 includes a first opening 131A, and an orthographic projection of the first opening 131A on the substrate 101 overlaps with an orthographic projection of at least one of the data lines 111 on the substrate 101. As such, with this arrangement, an overlapping area between the common electrode block 131 and at least one of the data lines 111 is reduced, so that a parasitic capacitance between the common electrode block 131, when reused as a touch electrode, and the data line 111 is reduced, and a problem of a large parasitic capacitance leading to a reduced touch signal-to-noise ratio is alleviated, thereby improving the touch performance of the display panel 100.

In the present application, an overlap between A and B may include a partial overlap between A and B, or an entire overlap between A and B.

As shown in FIG. 3 and FIG. 6, in some embodiments, the common electrode layer 13 is arranged on a side, away from the substrate 101, of the first conductive layer 11. In some embodiments, the common electrode layer 13 may be arranged between the substrate 101 and the first conductive layer 11.

In some embodiments, the common electrode blocks 131 each include a first opening 131A. An orthogonal projection of each of multiple first openings 131A on the substrate 101 overlaps with an orthogonal projection of each of the data lines 111 on the substrate 101. As shown in FIG. 2 and FIG. 5, the orthographic projection of each data line 111 on the substrate 101 partially overlaps with the orthographic projection of each first opening 131A on the substrate 101. As such, an overlapping area between the common electrode block 131 and the data line 111 is reduced, and a parasitic capacitance between the common electrode block 131 and the data line 111 is reduced. Also, a parasitic capacitance between the common electrode block 131, when reused as a touch electrode, and the data line 111 is reduced, so that the problem of a large parasitic capacitance leading to a reduced touch signal-to-noise ratio is further alleviated, and thereby further improving the touch performance of the display panel 100.

As shown in FIG. 2, FIG. 3, FIG. 5, and FIG. 6, in some embodiments, a size d1 of at least one of the data lines 111 along the first direction X is smaller than a size d2 of the first opening 131A along the first direction X. As such, it is beneficial for the first opening 131A to cover at least one of the data lines 111 in the first direction X, further reducing the overlapping area between the common electrode block 131 and at least one of the data lines 111 in the first direction X, and reducing the parasitic capacitance between the common electrode block 131 and at least one of the data lines 111. Also, the parasitic capacitance between the common electrode block 131, when reused as a touch electrode, and the data line 111 is reduced, so that the problem of a large parasitic capacitance leading to a reduced touch signal-to-noise ratio is further alleviated, and thereby further improving the touch performance of the display panel 100.

In some embodiments, a ratio of the size d2 of the first opening 131A along the first direction X to the size d1 of the data line 111 along the first direction X is greater than or equal to 1.5. As such, the size d1 of at least one of the data lines 111 along the first direction X is less than the size d2 of the first opening 131A along the first direction X.

In some embodiments, an orthographic projection of each data line 111 on the substrate 101 is located between two orthographic projections of two opposite edges of each first opening 131A on the substrate 101 in the first direction X. As such, the first opening 131A may cover at least one of the data lines 111 in the first direction X.

In some embodiments, a ratio of the size of the first opening 131A extending along the second direction Y to the size of the data line 111 extending along the second direction Y is greater than or equal to ½ and less than 1. As such, the overlapping area between the first opening 131A and the data line 111 in the second direction Y is increased, and the parasitic capacitance between the common electrode block 131, when reused as a touch electrode, and the data line 111 is reduced, so that the problem of a large parasitic capacitance leading to a reduced touch signal-to-noise ratio is further alleviated, and meanwhile it is ensured that parts, located on both sides of the first opening 131A in the second direction Y, of the common electrode block 131 are connectable.

It should be noted that a length of the data line 111 extending along the second direction Y is equal to a length of the data line 111. In case that the data line 111 extends in a straight line, the length of the data line 111 is equal to the length of the straight line. In case that the data line 111 is extends in a broken line or curve, the length of the data line 111 is equal to the length of the broken line or curve. Similarly, a size of the second opening 131B extending along the second direction Y is equal to an extension length of the second opening 131B.

As shown in FIG. 1 to FIG. 3, FIG. 5 and FIG. 6, in some embodiments, the first conductive layer 11 further includes multiple touch lines 112 arranged along the first direction X. The touch lines 112 are alternately arranged with the data lines 111 along the first direction X, and each touch line 112 is connected to each common electrode block 131. As such, the touch lines 112 and the data lines 111 are arranged at the same layer, and the touch lines 112 and the data lines 111 may be prepared at the same time, which simplifies the manufacturing process of the display panel 100. In some embodiments, the touch lines 112 are alternately arranged with the data lines 111 in a one-to-one manner along the first direction X, but not limited to this. In some embodiments, each touch line 112 is connected to each common electrode block 131 through a contact hole. The contact hole penetrates through an insulating layer between the first conductive layer 11 and the common electrode layer 13, for example, the contact hole penetrates through the insulating layer between the first conductive layer 11 and the common electrode layer 13 in FIG. 3 and FIG. 6. A position of the contact hole may be indicated by a black dot P in FIG. 1.

As shown in FIG. 2, in some embodiments, a width of the touch line 112 (a size d7 of the touch line 112 along the first direction X) is larger than a width of the data line 111 (the size d1 of the data line 111 along the first direction X). As such, an impedance of the touch line 112 is reduced and touch sensitivity is improved.

As shown in FIG. 2 to FIG. 4, in some embodiments, each common electrode block 131 further includes a second opening 131B. The second opening 131B and the first opening 131A are arranged at intervals along the first direction X, and an orthographic projection of the second opening 131B on the substrate 101 overlaps with an orthographic projection of at least one touch line 112 on the substrate 101. As such, with the arrangement of the second opening 131B in the common electrode block 31, the overlapping area between the touch line 112 and the common electrode block 131 is reduced, and the parasitic capacitance between the common electrode block 131 and the touch line 112, which are detached from each other, is reduced, so that the problem of a large parasitic capacitance leading to a reduced touch signal-to-noise ratio is further alleviated.

In some embodiments, a size d6 of the second opening 131B along the first direction X is greater than a size d7 of at least one touch line 112 along the first direction X. As such, the overlapping area between the touch line 112 and the common electrode block 131 is reduced, and the parasitic capacitance between the common electrode block 131 and the touch line 112, which are detached from each other, is reduced, so that the problem of a large parasitic capacitance leading to a reduced touch signal-to-noise ratio is further alleviated.

In some embodiments, two orthogonal projections of two opposite edges of the touch line 112 on the substrate 101 in the first direction X are located between two orthogonal projections of two opposite edges of the second opening 131B on the substrate 101 in the first direction X.

In some embodiments, a size of the first opening 131A extending along the second direction Y is smaller than a size of the second opening 131B extending along the second direction Y. As such, the size of the second opening 131B extending along the second direction Y is increased, so that the overlapping area between the touch line 112 and the common electrode block 131 is further reduced.

In some embodiments, a size of the first opening 131A along the first direction X is larger than a size of the second opening 131B along the first direction X. As such, the size of the first opening 131A along the first direction X is increased, the overlapping area between the common electrode block 131 and the data line 111 is further reduced.

As shown in FIG. 5 and FIG. 6, in some embodiments, the orthogonal projection of the first opening 131A on the substrate 101 overlaps with the orthogonal projection of at least one touch line 112 on the substrate 101. As such, the first opening 131A overlaps with both at least one data line 111 and at least one touch line 112, which are adjacent to the first opening. Furthermore, with the matching design between the first opening 131A and the touch line 112, the overlapping area between the touch line 112 and the common electrode block 131 is reduced, the parasitic capacitance between the common electrode block 131 and the touch line 112, which are detached from each other, is reduced, so that the problem of a large parasitic capacitance leading to a reduced touch signal-to-noise ratio is further alleviated.

As shown in FIG. 3 and FIG. 6, in some embodiments, the display panel 100 further includes a pixel electrode layer 14. The pixel electrode layer 14 is arranged on a side, away from the first conductive layer 11, of the common electrode layer 13. As shown in FIG. 1, the pixel electrode layer 14 includes multiple pixel electrodes 141 arranged in an array along the first direction X and the second direction Y. The pixel electrodes 141 are arranged in the display area 100A. Each common electrode block 131 overlaps with at least two pixel electrodes 141 on the substrate. In case that the display panel 100 is a liquid crystal display panel 100, when displaying on the display panel 100, a difference between voltages applied to the pixel electrode 141 and the common electrode layer 13 drives the liquid crystal to rotate. The pixel electrode layer 14 includes a transparent conductive material, and the transparent conductive material includes at least one of indium tin oxide and indium zinc oxide.

In some embodiments, the pixel electrode layer 14 further includes shielding lines 144, and each shielding line 144 is arranged between two adjacent pixel electrodes 141 in the first direction X. An orthographic projection of the shielding line 144 on the substrate 101 overlaps with the orthographic projection of at least one of the data lines 111 and the first opening 131A on the substrate 101. As such, the shielding line 144 shields an electric field produced by an electrical signal transmitted by the data line 111, so that a problem of light leakage in dark state caused by the electric field of the data line 111 is alleviated. Meanwhile, the shielding line 144 and the pixel electrode 141 may be prepared at the same time, which simplifies the manufacturing process of the display panel 100.

In related art, the shielding line is a part of the common electrode layer 13, and the parasitic capacitance between the common electrode layer and the data line is large, resulting in a reduced touch signal-to-noise ratio. In some embodiments of the present application, a part of the common electrode block 131 overlapping with the data line 111 is excavated, and meanwhile, the shielding line 144, which shields the electric field produced when the electrical signal is transmitted by the data line 111, is arranged at the pixel electrode layer 14, so that the problem of a reduced touch signal-to-noise ratio is alleviated, meanwhile the problem of light leakage in dark state is alleviated, and the manufacturing process of the display panel 100 is simplified.

In some embodiments, the display panel 100 may further include a shielding conductive layer (not shown in the Figures), and the shielding conductive layer is arranged between the common electrode layer 13 and the pixel electrode layer 14. The shielding conductive layer includes a shielding line 144, and the orthographic projection of the shielding line 144 on the substrate 101 overlaps with the orthographic projection of at least one of the data lines 111 and the first opening 131A on the substrate 101. As such, the risk of short circuit between the shield line 144 and other structures is reduced.

In some embodiments, the data line 111, the shielding line 144, and the first opening 131A all extend along the second direction Y, and the orthographic projection of each data line 111 on the substrate 101 overlaps with the orthographic projection of each shielding line 144 on the substrate 101 and the orthographic projection of each first opening 131A on the substrate 101. As such, the overlapping area between the data line 111 and the common electrode block 131 is reduced, and the shielding line 144 shields the electric field of the data line 111 to the greatest extent.

In some embodiments, a size of at least one of the data lines 111 along the first direction X is smaller than a size of the shielding line 144 along the first direction X. As such, it is beneficial for the shielding line 144 to cover at least one of the data lines 111 along the first direction X, so that the shielding line 144 may further shield the electric field produced by the electrical signal transmitted by the data line 111, and the problem of light leakage in dark state is further alleviated.

In some embodiments, the orthographic projection of each data line 111 on the substrate 101 is located within the orthographic projection of each shielding line 144 on the substrate 101. As such, the shielding line 144 may further shield the electric field produced by the electrical signal transmitted by the data line 111, and the problem of light leakage in dark state is further alleviated.

As shown in FIG. 2, FIG. 3, FIG. 5 and FIG. 6, in some embodiments, a size d3 of the shielding line 144 along the first direction X is smaller than a size d2 of the first opening 131A along the first direction X. As such, the overlapping area between the shielding line 144 and the common electrode block 131 is reduced, and the parasitic capacitance between the common electrode block 131 and the shielding line 144 is reduced, and the problem of a large parasitic capacitance leading to a reduced touch signal-to-noise ratio when the common electrode block 131 is reused as a touch electrode is further alleviated.

In some embodiments, the two orthogonal projections of the two opposite edges of the shield line 144 on the substrate 101 in the first direction X are located between the two orthogonal projections of the two opposite edges of the first opening 131A on the substrate 101 in the first direction X. As such, the overlapping area of the shielding line 144 and the common electrode block 131 in the first direction X is reduced.

As shown in FIG. 2 and FIG. 3, in some embodiments, the orthographic projection of the data line 111 on the substrate 101 and the orthographic projection of the first aperture 131A on substrate 101 are located between the orthographic projections of two adjacent pixel electrodes 141 on the substrate 101 in the first direction X.

As shown in FIG. 5 and FIG. 6, a part of the orthogonal projection of the first opening 131A on the substrate 101 is located between the orthogonal projections of the adjacent pixel electrodes 141 on the substrate 101 in the first direction X, and overlaps with the adjacent pixel electrodes 141. As such, the area of the first opening 131A is maximized, the area of the conductive part of the common electrode block 131 is reduced, and the parasitic capacitance between the common electrode block 131 and other conductive structures is reduced.

As shown in FIG. 2 to FIG. 3 and FIG. 5 and FIG. 6, the orthographic projection of the touch line 112 on the substrate 101 overlaps with the orthographic projection of the conductive part of the pixel electrode 141 on the substrate 101. As such, when displaying, the touch lines 112 may be covered by dark stripes in corresponding areas of the conductive parts of the pixel electrodes 141, reducing an influence of the touch lines 112 on an overall transmittance of the display panel.

As shown in FIG. 2 and FIG. 5, in some embodiments, at least one of the pixel electrodes 141 includes a first conductive part 142 and a second conductive part 143 arranged at intervals in the first direction X, and a slit is arranged between the first conductive part 142 and the second conductive part 143. The first conductive part 142 and the second conductive part 143 may both extend in the second direction Y. An orthogonal projection of the first conductive part 142 on the substrate 101 overlaps with the orthogonal projection of at least one of the touch lines 112 on the substrate 101. A width d4 of the first conductive part 142 along the first direction X is greater than a width d5 of the second conductive part 143 along the first direction X. As such, a liquid crystal light efficiency and transmittance around the first conductive part 142 are improved. Furthermore, the opaque touch lines 112 are covered by the dark stripes caused by an increase in the width of the first conductive part 142, so that the overall transmittance value of the pixel would not be affected.

The first conductive part 142 is connected to the second conductive part 143. In each pixel electrode 141, the number of the first conductive part 142 is less than the number of the second conductive part 143. As such, a transmittance of the pixel electrode 141 when displaying is improved. For example, in each pixel electrode 141, the number of the first conductive part 142 is 1. In other embodiments, the width d4 of the first conductive part 142 along the first direction X may be equal to the width d5 of the second conductive part 143 along the first direction X. As such, the manufacturing process of the pixel electrode 141 is simplified.

In some embodiments, the width d4 of the first conductive part 142 along the first direction X is greater than the width d7 of the touch line 112 along the first direction X. As such, the liquid crystal light efficiency and transmittance around the first conductive part 142 are further improved, and the opaque touch lines 112 may be efficiently covered by the dark stripes caused by an increase in the width of the first conductive part 142.

In some embodiments, the two orthogonal projections of the two opposite edges of the touch line 112 on the substrate 101 in the first direction X are located between the two orthogonal projections of the two opposite edges of the first conductive part 142 on the substrate 101 in the first direction X. As such, the liquid crystal light efficiency and transmittance around the first conductive part 142 are further improved, and the opaque touch lines 112 may be efficiently covered by the dark stripes caused by an increase in the width of the first conductive part 142.

In some embodiments, the first conductive part 142 is located at an edge of at least one of the pixel electrodes 141 in the first direction X. As such, in case that the touch line 112 overlaps with the first conductive part 142, it is also beneficial for the touch line 112 to not overlap with the common electrode block 131, so that the parasitic capacitance between the touch line 112 and the common electrode block 131 is reduced.

In other embodiments, the first conductive part 142 may be located between two adjacent second conductive parts 143 of each pixel electrode 141.

As shown in FIG. 8, when the width of the first conductive part 142 at the edge of the pixel electrode 141 is widened relative to the width of the second conductive part 143, the brightness around the first conductive part 142 increases (referring to part C in FIG. 5), and the dark stripes of the first conductive part 142 overlap with the touch lines 112, so that the overall transmittance of the display panel 100 would not be affected.

As shown in FIG. 1, FIG. 2, and FIG. 5, in some embodiments, the pixel electrode layer 14 further includes multiple connecting lines 145. The connecting lines 145 extend along the first direction X. Every two adjacent shielding lines 144 are connected through each connecting line 145. As such, the shielding lines 144 and the connecting lines 145 form a grid structure in the display area 100 A, so that the impedance between the shielding lines 144 and the connecting lines 145 is reduced.

In some embodiments, as shown in FIG. 1, the display panel 100 further includes a non-display area 100B arranged around the display area 100A, and the display panel 100 further includes a peripheral wiring 146. The peripheral wiring 146 is arranged in the non-display area 100B and is arranged around the display area 100A, and is connected to the connecting lines 145 and the shielding lines 144. The display panel further includes a drive unit 31. The drive unit 31 is connected to the peripheral wiring 146 to output a fixed voltage to the peripheral wiring 146. The peripheral wiring 146 transmits the fixed voltage to the shielding lines 144, so that the shielding lines 144 are used for light shielding. The fixed voltage may be a ground voltage or other constant voltage.

As shown in FIG. 2 and FIG. 5, in some embodiments, the display panel 100 further includes a second conductive layer 12. The second conductive layer 12 is arranged between the substrate 101 and the common electrode layer 13, and includes scanning lines 121 extending along the first direction X. An orthogonal projection of the scanning line 121 on the substrate 101 overlaps with the orthogonal projection of the connecting line 145 on the substrate 101. As such, the connecting lines 145 shield an electric field produced by an electrical signal transmitted by the scanning lines 121, so that a problem of light leakage in dark state caused by the electric field produced by the scanning lines 121 is alleviated.

As shown in FIG. 4 and FIG. 7, in some embodiments, each common electrode block 131 includes a common electrode conductive part 133, and the common electrode conductive part 133 includes multiple interconnected common electrode sub-blocks 132. The common electrode sub-blocks 132 are arranged in an array along the first direction X and the second direction Y. The first opening 131A is arranged between two adjacent common electrode sub-blocks 132 in the first direction X. As shown in FIG. 2 and FIG. 5, an orthographic projection of each common electrode sub-block 132 on the substrate 101 overlaps with the orthographic projection of each pixel electrode 141 on the substrate 101. As such, while the overlapping area between the common electrode block 131 and other structures is reduced, the area of the common electrode block 131 is ensured to be large, so that the impedance of the common electrode block 131 is reduced, and the display effect and touch effect are improved.

As shown in FIG. 2, FIG. 4, FIG. 5 and FIG. 7, in some embodiments, each common electrode block 131 further includes a first connecting part 1331 and a second connecting part 1332. The first connecting part 1331 extends along the first direction X, and two adjacent common electrode sub-blocks 132 in the first direction X are connected through the first connecting part. The second connecting part 1332 extends along the second direction Y, and two adjacent common electrode sub-blocks 132 in the second direction Y are connected through the second connecting part. As such, the common electrode sub-blocks 132 are connected through the first connecting part 1331 and the second connecting part 1332.

As shown in FIG. 2 and FIG. 4, in some embodiments, each common electrode sub-block 132 includes two sub-block side edges 132A arranged opposite to each other in the first direction X, and each sub-block side edge 132A includes two edge ends 132B arranged opposite to each other in the second direction Y. The first connecting part 1331 is connected to the edge end 132B. As such, adjacent common electrode sub-blocks 132 in the first direction X are connected to each other.

In some embodiments, a size of the first connecting part 1331 along the second direction Y is smaller than a size of the scanning line 121 along the second direction Y, or the size of the first connecting part 1331 along the second direction Y is larger than the size of the scanning line 121 along the second direction Y, that is, a width of the first connecting part 1331 is different from a width of the scanning line 121, so that a lateral coupling capacitance between the first connecting part 1331 and the scanning line 121 is reduced, the parasitic capacitance between the common electrode block 131 and the scanning line 121 is further reduced, and the problem of the parasitic capacitance leading to a reduced touch signal-to-noise ratio is alleviated.

As shown in FIG. 5 and FIG. 7, in some embodiments, each common electrode sub-block 132 has two sub-block side edges 132A arranged opposite to each other in the first direction X, and each sub-block side edge 132A includes two edge ends 132B arranged opposite to each other in the second direction Y. The first connecting part 1331 is connected to a part between the two edge ends 132B of the sub-block side edge 132A. As such, a distance between the first connecting part 1331 and the scanning line 121 is increased, the lateral coupling capacitance between the first connecting part 1331 and the scanning line 121 is reduced, and the parasitic capacitance between the common electrode block 131 and the scanning line 121 is further reduced, and the problem of the parasitic capacitance leading to a reduced touch signal-to-noise ratio is alleviated. For example, the first connecting part 1331 is connected to the middle part between the two edge ends 132B of the sub-block side edge 132A.

In some embodiments, each common electrode sub-block 132 includes two sub-block side edges 132A arranged opposite to each other in the first direction X, and each sub-block side edge 132A includes two edge ends 132B arranged relative to each other in the second direction Y. Some of the first connecting parts 1331 are connected to the edge end 132B, and others of the first connecting parts 1331 are connected to a part between the two edge ends 132B of the sub-block side edge 132A. As such, adjacent common electrode sub-blocks 132 in the first direction X are connected to each other, and the parasitic capacitance between the common electrode blocks 131 and the scanning lines 121 is reduced.

As shown in FIG. 5, in some embodiments, an overlapping part between the orthographic projection of at least one of the data lines 111 on the substrate 101 and the orthographic projection of the common electrode conductive part on the substrate 101 does not overlap with the orthographic projection of the shielding line 144 on the substrate 101. As such, the overlapping area between the shielding line 144 and the common electrode conductive part is reduced, the parasitic capacitance between the two is further reduced, and the problem of the parasitic capacitance leading to a reduced touch signal-to-noise ratio is alleviated.

As shown in FIG. 5, in some embodiments, the orthographic projection of the data line 111 on substrate 101 overlaps with the orthographic projection of the first connecting part 1331 on substrate 101, and the overlapping part between the orthographic projection of the data line 111 on substrate 101 and the orthographic projection of the first connecting part 1331 on substrate 101 does not overlap with the orthographic projection of the shielding line 144 on substrate 101. As such, with a part of the shielding line 144 excavated (referring to an excavated part 144A in FIG. 5), the overlapping area between the shielding line 144 and the common electrode conductive part 133 is reduced.

As shown in FIG. 2 and FIG. 4, in some embodiments, the display panel 100 further includes thin film transistors 16, and the thin film transistors 16 are arranged on the substrate 101. Each thin film transistor 16 includes a source 113, a drain 114, and a gate. The first conductive layer 11 may include the source 113 and the drain 114 arranged at intervals, and the source 113, the drain 114, the touch line 112 and the data line 111 are arranged at intervals. The scanning line 121 includes the gate. The source 113 is connected to the data line 111, and the drain 114 is connected to the pixel electrode 141. The common electrode block 131 further includes a third opening 131C, and an orthographic projection of the third opening 131C on the substrate 101 overlaps with an orthographic projection of the thin film transistor 16 on the substrate 101. As such, the overlapping area between the thin film transistor 16 and the common electrode block 131 is reduced, and the parasitic capacitance between the thin film transistor 16 and the common electrode block 131 is reduced, so that the problem of the parasitic capacitance leading to a reduced touch signal-to-noise ratio is alleviated.

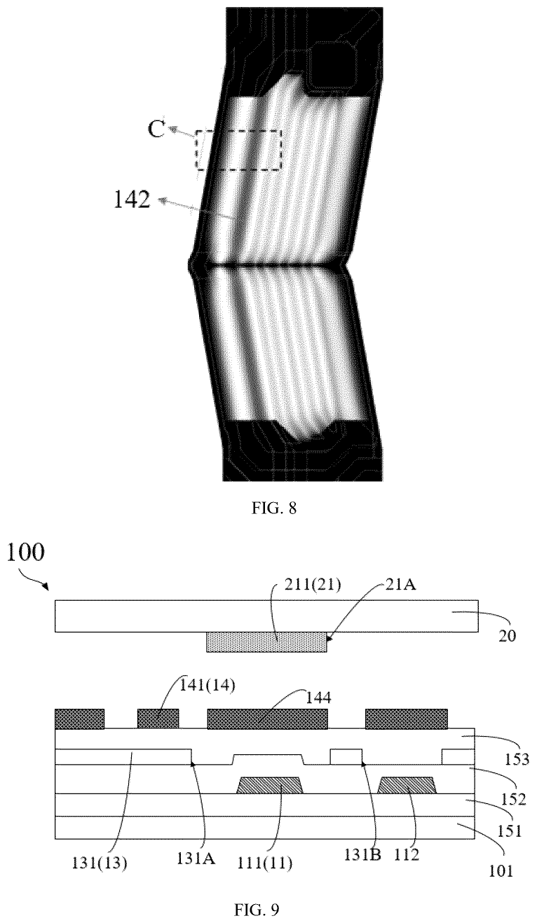

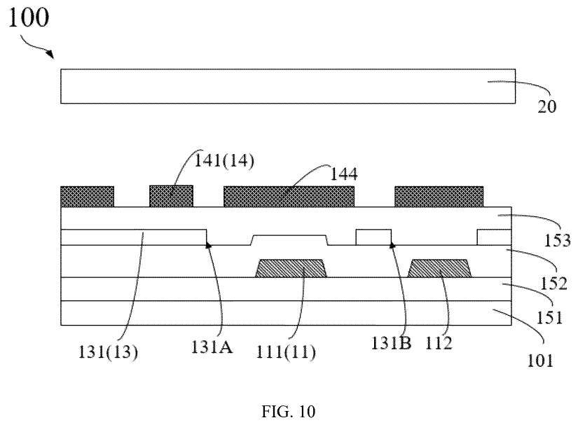

As shown in FIG. 3, FIG. 6, FIG. 9 and FIG. 10, in some embodiments, a first insulating layer 151 is arranged between the first conductive layer 11 and the second conductive layer 12. The second conductive layer 12 and the common electrode layer 13 are arranged in a second insulating layer 152. A third insulating layer 153 is arranged between the common electrode layer 13 and the pixel electrode layer 14. A contact hole for connecting the control line 112 and the common electrode block 131 is located in the second insulating layer 152.

In some embodiments, the display panel 100 further includes a semiconductor layer, and the semiconductor layer is arranged on the first insulating layer 151. The semiconductor layer includes an active layer of the thin film transistor.

As shown in FIG. 9, the display panel 100 may further include an opposite substrate 20 arranged opposite to the array substrate 10. A light-shielding layer 21 is arranged on a surface of the substrate 20 facing the substrate 101. The light-shielding layer 21 includes light-shielding parts 211 and light-shielding part openings 21A penetrating through the light-shielding parts 211. The light-shielding part openings 21A overlap with the pixel electrodes 141. The light-shielding parts 211 overlaps with the data lines 111, the scanning lines 121, and the thin film transistors 16. The display panel 100 further includes a liquid crystal layer between the array substrate 10 and the display panel 100. The light-shielding part 211 may include a black matrix.

As shown in FIG. 10, in some embodiments, in case that the screen line 144 is arranged for light shielding, the black matrix may be not arranged on the opposite substrate 20 to increase an opening rate of the display panel 100. In table 1, a touch parasitic capacitance of the display panel according to FIG. 2, that of the display panel according to FIG. 5, as well as that of a display panel of a comparative embodiment are illustrated. Embodiment 1 corresponds to the display panel according to FIG. 2, and Embodiment 2 corresponds to the display panel according to FIG. 5. The display panel of comparative Embodiment 1 is the display panel where openings for the data lines are not formed in the common electrode layer.

TABLE 1

| | Comparative | | |
|---|---|---|---|
| | Embodiment 1 | Embodiment 1 | Embodiment 2 |
| Touch parasitic | 320 | 218 | 196 |
| capacitance/pF | | | |

According to Table 1, it can be seen that the touch parasitic capacitance of the display panel according to some embodiments of the present application is significantly reduced.

Based on the same invention concept, the present application further provides a display device, and the display device includes the display panel 100 described above.

The above embodiments are only used to help understand the technical proposal and the core idea of the present application. Those skilled in this field should understand that they may still modify the technical solutions recorded in the aforementioned embodiments, or replace some of the technical features equivalently. These modifications or replacements do not deprive the nature of the corresponding technical solutions from the scope of the technical solutions of the embodiments of the present application.

1. A display panel, wherein the display panel comprises a display area, and the display panel comprises:
a substrate;
a first conductive layer, arranged on a side of the substrate and comprising a plurality of data lines arranged in a first direction, wherein the data lines are arranged in the display area; and
a common electrode layer, arranged on a side of the first conductive layer and the substrate, and comprising a plurality of common electrode blocks arranged in an array along the first direction and a second direction, wherein the common electrode blocks are located in the display area, each of the common electrode blocks is reused as one touch electrode, at least one of the common electrode blocks comprises a first opening, an orthographic projection of the first opening on the substrate overlaps with an orthographic projection of at least one of the data lines on the substrate, and the first direction intersects with the second direction.

2. The display panel of claim 1, further comprising:
a pixel electrode layer, arranged on a side, away from the first conductive layer, of the common electrode layer, and comprising a plurality of pixel electrodes and a plurality of shielding lines arranged in an array along the first direction and the second direction, wherein the pixel electrodes are arranged in the display area, each of the shielding lines is arranged between every two adjacent pixel electrodes in the first direction, and an orthographic projection of the shielding line on the substrate overlaps with an orthographic projection of at least one of the data lines and the first opening on the substrate.

3. The display panel of claim 2, wherein a size of at least one of the data lines along the first direction is smaller than a size of the first opening along the first direction and a size of the shielding line along the first direction.

4. The display panel of claim 3, wherein the size of the shielding line along the first direction is smaller than the size of the first opening along the first direction.

5. The display panel of claim 2, wherein the first conductive layer further comprises a plurality of touch lines arranged along the first direction, the touch lines are alternately arranged with the data lines along the first direction, and each of the touch lines is connected to a corresponding one of the common electrode blocks.

6. The display panel of claim 5, wherein an orthogonal projection of the first opening on the substrate overlaps with an orthogonal projection of at least one of the touch lines on the substrate.

7. The display panel of claim 5, wherein at least one of the pixel electrodes comprises a first conductive part and a second conductive part arranged at intervals in the first direction, an orthogonal projection of the first conductive part on the substrate overlaps with an orthogonal projection of at least one of the touch lines on the substrate, and a width of the first conductive part along the first direction is greater than a width of the second conductive part along the first direction.

8. The display panel of claim 7, wherein a width of the first conductive part along the first direction is greater than a width of the touch wire along the first direction.

9. The display panel of claim 7, wherein the first conductive part is located at an edge of at least one of the pixel electrodes in the first direction.

10. The display panel of claim 5, wherein at least one of the common electrode blocks further comprises a second opening, the second opening and the first opening are arranged at intervals along the first direction, and an orthographic projection of the second opening on the substrate overlaps with an orthographic projection of at least one of the touch lines on the substrate.

11. The display panel of claim 10, wherein a size of the second opening along the first direction is greater than a size of at least one of the touch lines along the first direction.

12. The display panel of claim 2, further comprising:
thin film transistors, arranged on the substrate, each of the thin film transistors comprising a source, a drain and a gate, wherein the sources are connected to the data lines, and the drains are connected to the pixel electrodes; and
at least one of the common electrode blocks further comprises a third opening, and an orthographic projection of the third opening on the substrate overlaps with an orthographic projection of the thin film transistor on the substrate.

13. The display panel of claim 2, wherein each of the common electrode blocks comprises:
a common electrode conductive part, comprising a plurality of interconnected common electrode sub-blocks, wherein the common electrode sub-blocks are arranged in an array along the first direction and the second direction, the first opening is arranged between two adjacent common electrode sub-blocks in the first direction, and an orthographic projection of each of the common electrode sub-blocks on the substrate overlaps with an orthographic projection of each of the pixel electrodes on the substrate.

14. The display panel of claim 13, wherein each of the common electrode blocks further comprises:
a first connecting part, extending along the first direction, wherein two adjacent common electrode sub-blocks in the first direction are connected through the first connecting part; and
a second connecting part, extending along the second direction, wherein two adjacent common electrode sub-blocks in the second direction are connected through the second connecting part.

15. The display panel of claim 13, wherein each of the common electrode sub-blocks comprise two sub-block side edges arranged opposite to each other in the first direction, and each of the sub-block side edges comprises two edge ends arranged opposite to each other in the second direction; and
the first connecting part is connected to the edge end, and/or, the first connecting part is connected to a part between the two edge ends of the sub-block side edges.

16. The display panel of claim 13 wherein an overlapping part between an orthographic projection of at least one of the data lines on the substrate and an orthographic projection of the common electrode conductive part on the substrate is non-overlapping with an orthographic projection of a shielding line on the substrate.

17. The display panel of claim 2, wherein the pixel electrode layer further comprises:
a plurality of connecting lines, extending along the first direction, wherein every two adjacent shielding lines are connected through each of the connecting lines.

18. The display panel of claim 17, further comprising:
a second conductive layer, arranged between the substrate and the common electrode layer, and comprising scanning lines extending along the first direction, wherein an orthogonal projection of each of the scanning lines on the substrate overlaps with an orthogonal projection of each of the connecting lines on the substrate.

19. A display device, comprising a display panel, wherein the display panel comprises a display area, and the display panel comprises:
a substrate;
a first conductive layer, arranged on a side of the substrate and comprising a plurality of data lines arranged in a first direction, wherein the data lines are arranged in the display area; and
a common electrode layer, arranged on a side of the first conductive layer and the substrate, and comprising a plurality of common electrode blocks arranged in an array along the first direction and a second direction, wherein the common electrode blocks are located in the display area, each of the common electrode blocks is reused as one touch electrode, at least one of the common electrode blocks comprises a first opening, an orthographic projection of the first opening on the substrate overlaps with an orthographic projection of at least one of the data lines on the substrate, and the first direction intersects with the second direction.

20. The display device of claim 19, wherein the display panel further comprises:
a pixel electrode layer, arranged on a side, away from the first conductive layer, of the common electrode layer, and comprising a plurality of pixel electrodes and a plurality of shielding lines arranged in an array along the first direction and the second direction, wherein the pixel electrodes are arranged in the display area, each of the shielding lines is arranged between every two adjacent pixel electrodes in the first direction, and an orthographic projection of the shielding line on the substrate overlaps with an orthographic projection of at least one of the data lines and the first opening on the substrate.
